(19) United States
(12) Patent Application Publication
(10) Pub. No.: US 2022/0014055 A1
(43) Pub. Date: Jan. 13, 2022

(54) ROTOR ASSEMBLY FOR AN ELECTRIC MOTOR

(71) Applicant: MILWAUKEE ELECTRIC TOOL CORPORATION, Brookfield, WI (US)

(72) Inventors: Russell M. Rapant, Menomonee Falls, WI (US); Brian Trump, Germantown, WI (US); Jeffrey C. Hessenberger, Neosho, WI (US)

(21) Appl. No.: 17/373,923

(22) Filed: Jul. 13, 2021

Related U.S. Application Data
(60) Provisional application No. 63/055,933, filed on Jul. 24, 2020.
(60) Provisional application No. 63/050,951, filed on Jul. 13, 2020.

(51) Int. Cl. H02K 1/27; H02K 9/04; H02K 15/03

(52) U.S. Cl. CPC H02K 1/276; H02K 15/03; H02K 9/04

(57) ABSTRACT

An electric motor includes a stator and a rotor assembly received in the stator. The rotor assembly includes a shaft, a rotor core, a rotor molding that is molded to the rotor core, and a fan. A coupler is formed on the rotor molding and a corresponding mounting hub is formed on the fan. The shaft is pressed into the rotor core after the rotor molding is molded to the rotor core, and the fan is affixed to the rotor molding by connecting the coupler and the mounting hub after the shaft is pressed into the rotor core.

### CROSS-REFERENCE TO RELATED APPLICATIONS

This application claims priority to co-pending U.S. Provisional Patent Application No. 63/055,933, filed Jul. 24, 2020, and to co-pending U.S. Provisional Patent Application No. 63/050,951, filed Jul. 13, 2020, the entire content of each of which is hereby incorporated by reference.

### FIELD OF THE INVENTION

The present invention relates to power tools, and more particularly to power tools including electric motors having a molded rotor assembly.

### BACKGROUND OF THE INVENTION

Tools, such as power tools, can include an electric motor having a rotor assembly to rotate a shaft and generate a torque output. The rotor assembly may include a fan.

### SUMMARY OF THE INVENTION

In one construction, an electric motor includes a stator and a rotor assembly received in the stator. The rotor assembly includes a shaft, a rotor core, a rotor molding that is molded to the rotor core, and a fan. A coupler is formed on the rotor molding and a corresponding mounting hub is formed on the fan. The shaft is pressed into the rotor core after the rotor molding is molded to the rotor core, and the fan is affixed to the rotor molding by connecting the coupler and the mounting hub after the shaft is pressed into the rotor core.

In another construction, a method of manufacturing an electric motor includes molding a rotor molding to a rotor core. The rotor molding includes a coupler formed thereon. The method also includes pressing a shaft into the rotor core. The method further includes connecting the coupler to a mounting hub formed on a fan to thereby affix the fan to the rotor molding and form a rotor assembly. The method also includes receiving the rotor assembly into a stator.

In another construction, an electric motor includes a stator and a rotor assembly received in the stator. The rotor assembly includes a shaft, a rotor core, a rotor molding that is molded to the rotor core, and a fan. A notch is formed on the shaft and a corresponding rib is formed on the fan. The shaft is pressed into the rotor core after the rotor molding is molded to the rotor core, and the fan is affixed to the shaft by connecting the rib and the notch after the shaft is pressed into the rotor core.

In another construction, a method of manufacturing an electric motor includes molding a rotor molding to a rotor core. The method also includes pressing a shaft into the rotor core. The method further includes affixing a fan to the shaft by connecting a rib formed on the fan and a notch formed on the shaft. The rotor molding, the rotor core, shaft, and the fan form a rotor assembly. The method also includes receiving the rotor assembly into a stator.

In another construction, an electric motor includes a stator and a rotor assembly received in the stator. The rotor assembly includes a shaft, a rotor core, a first rotor molding that is molded to the rotor core to form a molded rotor, and a second rotor molding that is molded to the molded rotor. The second rotor molding is molded as a separate injection molding after the first rotor molding. The shaft is pressed into the rotor core after the second rotor molding is molded.

In another construction, a method of manufacturing an electric motor includes molding a first rotor molding to a rotor core to form a molded rotor. The method also includes molding a second rotor molding to the molded rotor, the second rotor molding being molded as a separate injection molding after the first rotor molding. The method further includes pressing a shaft into the rotor core. The molded rotor, the second rotor molding, and the shaft form a rotor assembly. The method also includes receiving the rotor assembly into a stator.

In another construction, an electric motor includes a stator and a rotor assembly received in the stator. The rotor assembly includes a shaft, a rotor core, a plurality of magnets, a first rotor molding that is molded to the rotor core to form a molded rotor, and a second rotor molding that is molded to the molded rotor. The magnets are inserted into the molded rotor and then the second rotor molding is molded as a separate injection molding. The shaft is pressed into the rotor core after the second rotor molding is molded.

In another construction, a method of manufacturing an electric motor includes molding a first rotor molding to a rotor core to form a molded rotor. The method also includes inserting a plurality of magnets into the molded rotor. The method further includes molding a second rotor molding to the molded rotor, the second rotor molding being molded as a separate injection molding after the first rotor molding. The method also includes pressing a shaft into the rotor core. The molded rotor, the plurality of magnets, the second rotor molding, and the shaft form a rotor assembly. The method further includes receiving the rotor assembly into a stator.

Other aspects of the application will become apparent by consideration of the detailed description and accompanying drawings.

### BRIEF DESCRIPTION OF THE DRAWINGS

FIG. 1 is an exploded view of a prior art rotor assembly for an electric motor.

FIG. 2 is a perspective view of a rotor assembly according to an embodiment of the present invention.

FIG. 3 is an exploded view of the rotor assembly of FIG. 2.

FIG. 4 is a perspective view of a molded rotor body of the rotor assembly of FIG. 2.

FIG. 5 is a perspective view of a rotor molding of the rotor assembly of FIG. 2.

FIG. 6 is a perspective view of a fan of the rotor assembly of FIG. 2.

FIG. 7 is a cross-sectional view of the rotor assembly of FIG. 2.

FIG. 8 is a flowchart depicting a method of manufacturing a rotor assembly for an electric motor according to an embodiment of the present invention.

FIG. 9 is a perspective view of a rotor assembly according to another embodiment of the invention.

FIG. 10 is an exploded view of the rotor assembly of FIG. 9.

FIG. 11 is a detail view of a portion of a shaft of the rotor assembly of FIG. 9.

FIG. 12 is a cross-sectional view of the rotor assembly of FIG. 9.

FIG. 13 is a flowchart depicting a method of manufacturing a rotor assembly for an electric motor according to an embodiment of the present invention.

FIG. 14 is a perspective view of a rotor assembly according to another embodiment of the invention.

FIG. 15 is a cross-sectional view of the rotor assembly of FIG. 14.

FIG. 16A-16C illustrate the results of manufacturing steps for the rotor assembly of FIG. 14.

FIG. 17 is a flowchart depicting a method of manufacturing a rotor assembly for an electric motor according to an embodiment of the present invention.

FIG. 18 is a perspective view of a rotor assembly according to another embodiment of the invention.

FIG. 19 is a cross-sectional view of the rotor assembly of FIG. 18, with the shaft removed.

FIG. 20A-20D illustrate the results of manufacturing steps for the rotor assembly of FIG. 18.

FIG. 21 is a flowchart depicting a method of manufacturing a rotor assembly for an electric motor according to an embodiment of the present invention.

FIG. 22 is a perspective view of a rotor assembly according to another embodiment of the invention, illustrated with an end casing.

FIG. 23 is a perspective view of the rotor assembly of FIG. 22, with the end casing removed.

FIG. 24 is a cross-sectional view of the rotor assembly of FIG. 22.

FIG. 25 is a perspective view of a rotor assembly according to another embodiment of the invention.

FIG. 26 is a cross-sectional view of the rotor assembly of FIG. 25.

FIG. 27 is a perspective view of a fan of the rotor assembly of FIG. 25.

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

### DETAILED DESCRIPTION

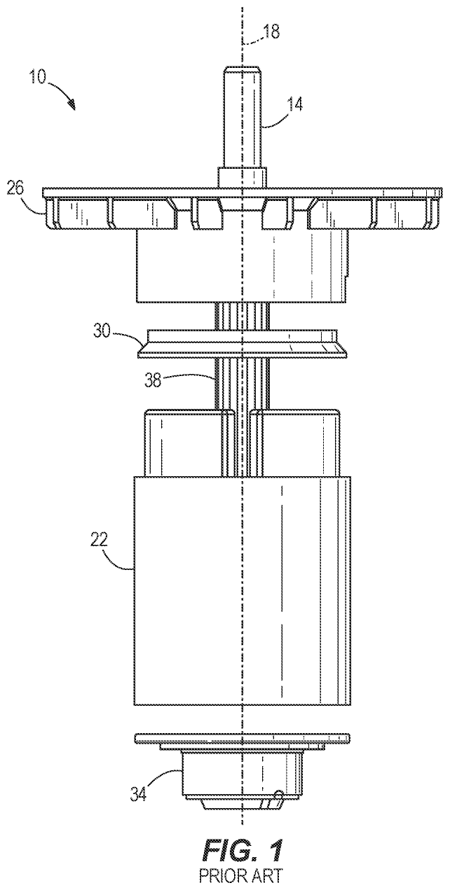

FIG. 1 illustrates an exploded view of a prior art rotor assembly 10 for an electric motor (not shown). The rotor assembly 10 is supported for rotation with respect to a stator (not shown) and includes a solid shaft 14 that extends along a longitudinal or rotational axis 18. The rotor assembly 10 also includes a rotor core 22, a fan 26, a rubber ring 30, and a balance bushing 34. The rotor core 22 is comprised of a solid ferromagnetic body and/or a stack of ferromagnetic plates that are stacked along the rotational axis 18. The shaft 14 is received into a central aperture (not shown) formed in the rotor core 22. The fan 26 is coupled to the shaft 14 adjacent the rotor core 22 so that the fan 26 rotates with the shaft 14 and provides cooling air to the electric motor. The rubber ring 30 is disposed between the fan 26 and the rotor core 22. The balance bushing 34 is coupled to the shaft 14 adjacent the rotor core 22 and opposite the fan 26 to rotationally balance the rotor assembly 10.

An outer surface of the shaft 14 includes knurls or splines 38 that engage the central aperture of the rotor core 22 to rotatably fix the rotor core 22 to the shaft 14. Moreover, the central aperture of the rotor core 22 includes notches (not shown) that are used for orientation of parts for magnetization of magnets during the assembly process. In the prior art rotor assembly 10, imperfect knurls formed on the shaft 14 combined with the notches in the rotor core 22 can be a source of imbalance in the rotor assembly 10. Thus, the balance bushing 34 is required to balance the rotor assembly 10.

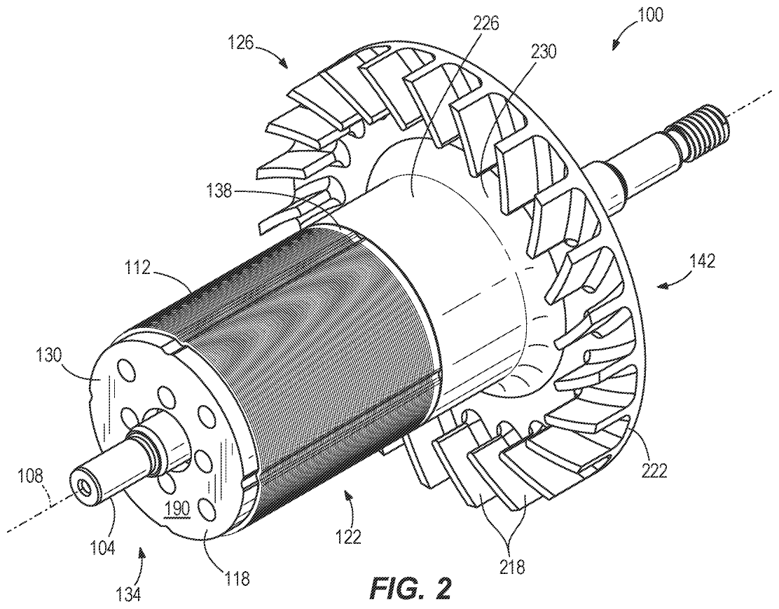

FIGS. 2-7 illustrate a molded rotor assembly 100 (and portions thereof) for an electric motor (not shown) according to the present invention. The electric motor may be used in various different tools, such as power tools (e.g., rotary hammers, pipe threaders, cutting tools, etc.), outdoor tools (e.g., trimmers, pole saws, blowers, etc.), and other electrical devices (e.g., motorized devices, etc.).

The electric motor is configured as a brushless DC motor. In some embodiments, the motor may receive power from an on-board power source (e.g., a battery, not shown). The battery may include any of a number of different nominal voltages (e.g., 12V, 18V, etc.), and may be configured having any of a number of different chemistries (e.g., lithium-ion, nickel-cadmium, etc.). Alternatively, the motor may be powered by a remote power source (e.g., a household electrical outlet) through a power cord. The motor includes a substantially cylindrical stator (not shown) operable to produce a magnetic field. The rotor assembly 100 is rotatably supported by a solid shaft 104 and configured to co-rotate with the shaft 104 about a longitudinal or rotational axis 108.

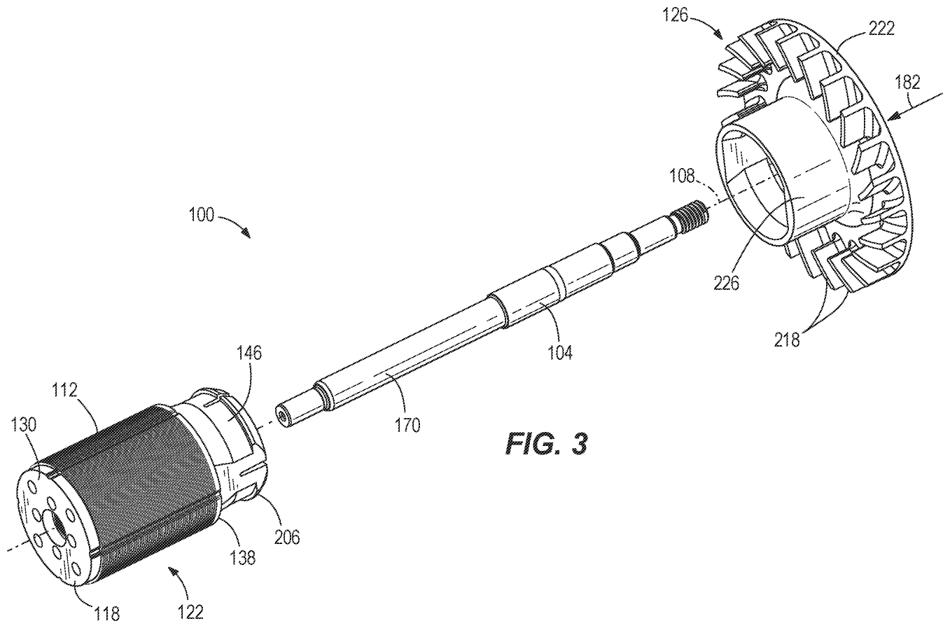

With reference to FIG. 3, the rotor assembly 100 includes a rotor core 112, a rotor molding 118 (i.e., a first molding) (FIG. 5) that is molded to the rotor core 112 to form a molded rotor body 122 and a separate fan 126 that is coupled to the molded rotor body 122. In the illustrated embodiment, the fan 126 is snap-fitted onto the rotor molding 118 by a snap fitting. In the illustrated embodiment, the rotor molding 118 and the fan 126 are formed of an insulative material (e.g., a plastic). In other embodiments, the fan 126 is not a molded but machined, for example.

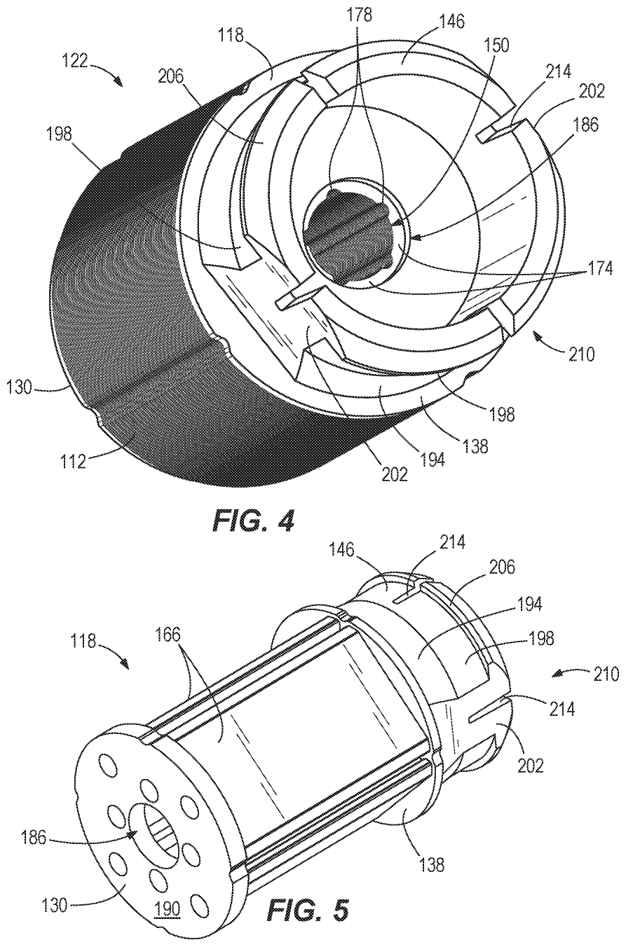

With reference to FIGS. 4 and 5, the rotor molding 118 is molded to the rotor core 112 and has a first magnet retention portion 130 (i.e., an axial end wall) formed at a first axial end 134 and a second magnet retention portion 138 (i.e., an axial end wall) at a second axial end 142, opposite the first axial end 134. The rotor molding 118 further includes a coupler 146 formed at the second axial end 142, extending away from the second magnet retention portion 138. In the illustrated embodiment, the coupler 146 is configured as a snap fitting to connect the fan 126.

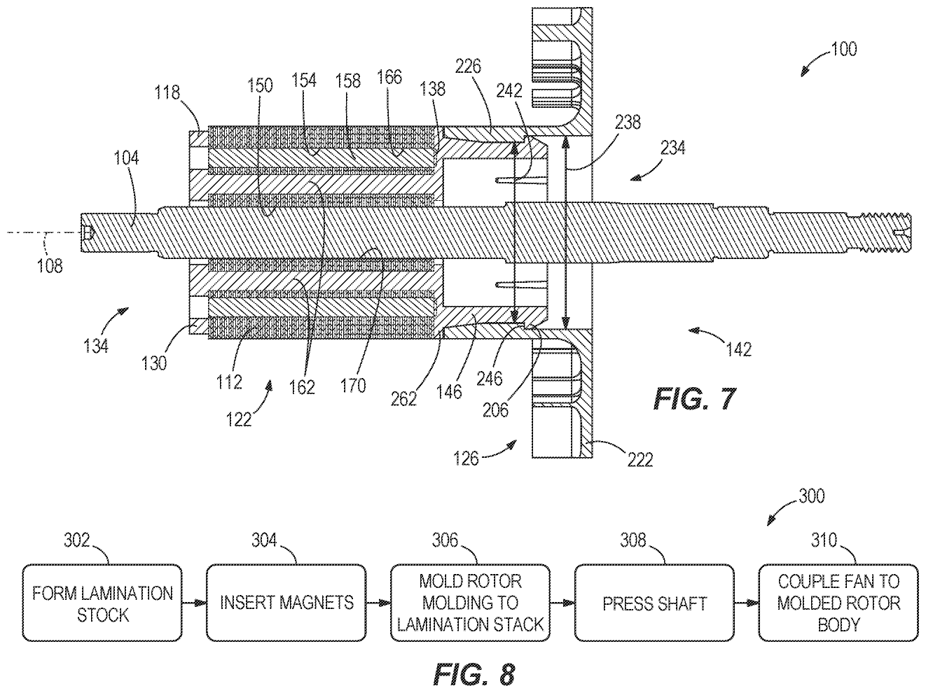

With reference to FIG. 4, the rotor core 112 defines a longitudinally extending central aperture 150 that receives the shaft 104 by a press-fit engagement. Magnet slots 154 (FIG. 7) are formed in the rotor core 112 and configured to receive permanent magnets 158. The rotor core 112 also includes injection channels 162 formed about the central aperture 150 and extending longitudinally between the first axial end 134 and the second axial end 142. When the rotor molding 118 is molded to the rotor core 112, the insulative material of the rotor molding 118 flows through the channels 162 and joins the coupler 146 to the magnet retention portions 130, 138. The insulative material also extends around the magnets 158 within the magnet slots 154 to form magnet holding portions 166 (FIG. 5). The magnet holding portions 166 of the rotor molding 118 extend through the magnet slots 154, connecting the first magnet retention portion 130 and the second magnet retention portion 138. The magnet holding portions 166 also surround the permanent magnets 158 to retain the magnets 158 within the magnet slots 154. In some embodiments, the insulative material does not completely surround the magnets. For example, in some embodiments, the insulative material is only positioned on 3 or less sides of the magnet. In still other embodiments, the magnet slots in the rotor core are designed such that the insulative material is only on one side and the process of injecting the material forces the magnet in a pre-determined direction.

The molded rotor body 122 is secured to the shaft 104 by an interference fit (e.g., by press-fit). With reference to FIGS. 3 and 4, unlike the prior art shaft 14 having splines 38 described above, the shaft 104 of the present invention includes a smooth annular outer surface 170. In the illustrated embodiment, the smooth annular outer surface 170 is cylindrical and devoid of splines or other retention features. The central aperture 150 of the rotor core 112 is partially defined by press-fit portions 174 (FIG. 4) that contact and engage the smooth annular outer surface 170 of the shaft 104 to transfer torque between the molded rotor body 122 and the shaft 104. The central aperture 150 is further defined by relief notches 178 formed in the rotor core 112 between adjacent press-fit portions 174 to relieve stresses during the pressing process. By providing the shaft 104 with the smooth annular outer surface 170 and pressing the shaft 104 into the central aperture 150, the rotor assembly 100 of the present invention eliminates the imbalance issue associated with the prior art splines 38. Thus, the rubber ring 30 and the balance bushing 34 of the prior art rotor assembly 10 are eliminated in the molded rotor assembly 100.

In the rotor assembly 100 of the present invention, the shaft 104 is pressed into the molded rotor body 122 after the rotor molding 118 is molded to the rotor core 112 by injection molding, for example. This is an improvement over the prior art process of pressing the shaft into the rotor core prior to the molding process, because it avoids the costs of having many sets of molding inserts for different shaft sizes and reduces the cost of the shaft itself.

The shaft 104 is pressed into the molded rotor body 122 from the second axial end 142 (i.e., the end with the coupler 146) as indicated by the arrow 182 shown in FIG. 3, and the molded rotor body 122 is supported at the first axial end 134 during the pressing operation. The magnet retention portions 130, 138 each include shaft openings 186 (FIGS. 4 and 5) that correspond to the central aperture 150 to permit the shaft 104 to pass therethrough. With reference to FIG. 5, the first magnet retention portion 130 of the rotor molding 118 defines a bearing surface 190, and the molded rotor body 122 is supported at the bearing surface 190 as the shaft 104 is pressed into the molded rotor body 122 from the second axial end 142. In other embodiments (not shown), the bearing surface may alternatively be provided on the coupler 146 or the second magnet retention portion 138. In such embodiments, the shaft 104 may be pressed into the molded rotor body 122 from the first axial end 134 (i.e., in a direction opposite to the arrow 182 shown in FIG. 3). A fixture (not shown) may be employed to support the molded rotor body 122 during the shaft pressing operation.

With reference to FIGS. 4 and 5, the coupler 146 is positioned at the second axial end 142 of molded rotor body 122. In the illustrated embodiment, the coupler 146 extends from the second magnet retention portion 138. In other embodiments, the coupler 146 directly abuts the rotor core 112. The coupler 146 includes beveled portions 194, arcuate portions 198, planar portions 202, and a lip 206 formed at a distal end 210 of the coupler 146. The coupler 146 also includes a plurality of reliefs 214 formed in the lip 206 and extending axially into the arcuate portions 198 and the planar portions 202. As explained in greater detail below, the reliefs 214 permit the coupler 146 to deflect as the snap-fit connection is made between the coupler 146 and the fan 126.

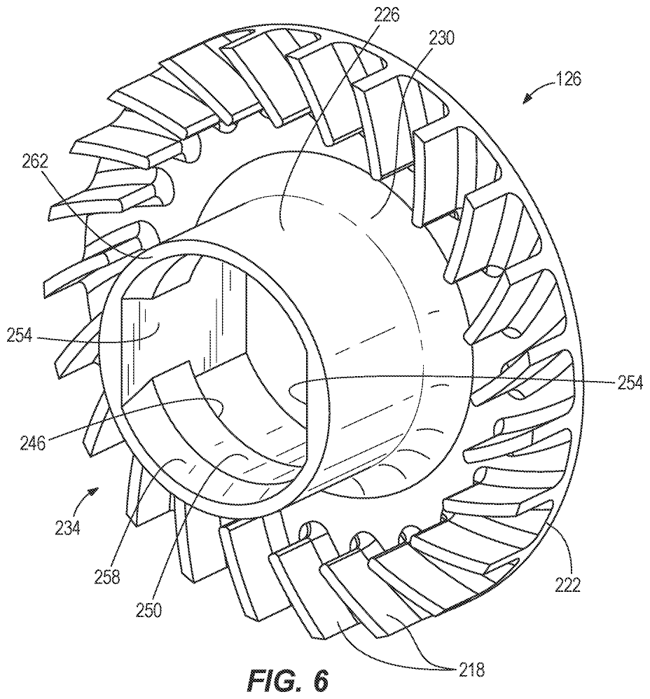

With reference to FIG. 6, the fan 126 is separate from the molded rotor body 122 and is separately formed prior to completing assembling the rotor assembly 100. In the illustrated embodiment, the fan 126 is a separately molded piece. The fan 126 includes a plurality of vanes 218 formed on an end plate 222 that generate an airflow upon rotation of the fan 126. The fan 126 also includes a mounting hub 226 extending axially away from the end plate 222. In the illustrated embodiment, the mounting hub 226 is connected to the end plate 222 by a rounded corner 230. The fan 126 includes an opening 234 that extends through the end plate 222 and the mounting hub 226. The opening 234 defines a first diameter 238 formed in the end plate 222 (FIG. 7). The opening 234 decreases to a second diameter 242, smaller than the first diameter 238 to create a ledge 246 at a position axially spaced from the end plate 222. At the mounting hub 226 end of the fan 126, the opening 234 is at least partially defined by two arcuate portions 250 and two linear portions 254. In the illustrated embodiment, the arcuate portions 250 have a beveled portion 258 and the linear portions 254 are planar. The linear portions 254 of the opening 234 on the mounting hub 226 correspond to the planar portions 202 of the coupler 146 on the rotor molding 118.

With reference to FIG. 7, the fan 126 is coupled to the molded rotor body 122 by snap-fitting the coupler 146 to the mounting hub 226. When assembled, the lip 206 formed on the coupler 146 engages the ledge 246 formed on the mounting hub 226. When assembled, the molded rotor body 122 and the fan 126 are coupled to each other for co-rotation. Specifically, the planar portions 202 of the coupler 146 rotationally lock the fan 126 relative to the molded rotor body 122. In the illustrated embodiment, the connection between the molded rotor body 122 and fan 126 is not reversible (i.e., the fan 126 is designed to prohibit disassembly from the molded rotor body 118). In other words, the coupler 146 and mounting hub 226 form a permanent snap-fit connection. In other embodiments, the snap fit coupling is reversible (i.e., removable) to facilitate maintenance and servicing of the rotor assembly. The coupler 146 deflects as it is inserted into the mounting hub 226 until the lip 206 passes over the ledge 246 at which point the distal end 210 of the coupler 146 deflects radially outward into locking engagement with the fan 126. The beveled portion (i.e., tapered section) 194 of the coupler 146 engages the beveled portion (i.e., tapered section) 258 of the mounting hub 226 to locate the fan 126 in the proper axial and radial positions, and provides surfaces against which to generate a force for fitting the fan 126 onto the coupler 146 and holding the lip 206 against the ledge 246. An axial end surface 262 of the mounting hub 226 abuts the second magnet retention portion 138 on the rotor molding 118. In the illustrated embodiment, the coupler 146 is received within the mounting hub 226. In other embodiments, the mounting hub is received within the coupler. As explained in more detail below, snapping on the fan to the motor rotor body simplifies the assembly process of the rotor assembly.

FIG. 8 illustrates a method 300 of manufacturing a rotor assembly for an electric motor according to the present invention. In general, the illustrated method 300 includes a step 302 to form a rotor core, a step 304 to insert permanent magnets into magnet slots formed in the rotor core, a step 306 to mold a rotor molding to the rotor core to form a molded rotor body, a step 308 to press a shaft into a central aperture formed in the molded rotor body, and a step 310 to snap-fit a fan to the molded rotor body. The method 300 of FIG. 8 differs from prior art methods in that the pressing of the shaft occurs at step 308 after the rotor molding is molded to the rotor core at step 306. In addition, the method 300 of FIG. 8 differs from prior art methods in that the fan is coupled to the rotor molded body at step 310 after the pressing of the shaft at step 308. In some embodiments, the process may omit one or more of the steps 302 and 304 yet still fall within the scope of the present invention. In some embodiments, the process may conduct steps 308 and step 310 in reverse order (i.e., the fan is pressed on before the shaft is pressed into the rotor core).

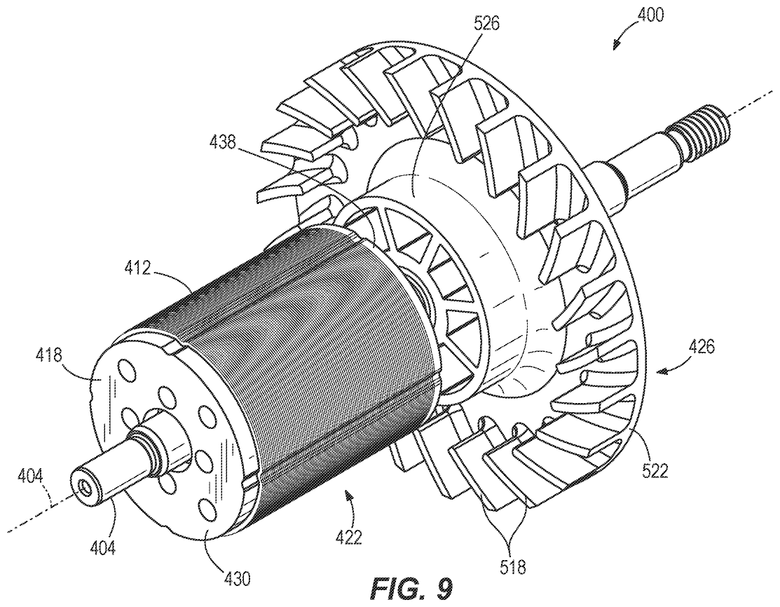

FIGS. 9-12 illustrate another embodiment of a rotor assembly 400 like the rotor assembly 100 described above, with like features shown with similar reference numerals plus “300.” The rotor assembly 400 includes a rotor core 412, a rotor molding 418 (i.e., a first molding) that is molded to the rotor core 412 to form a molded rotor body 422 and a separate fan 426 that is coupled to the shaft 404 for co-rotation.

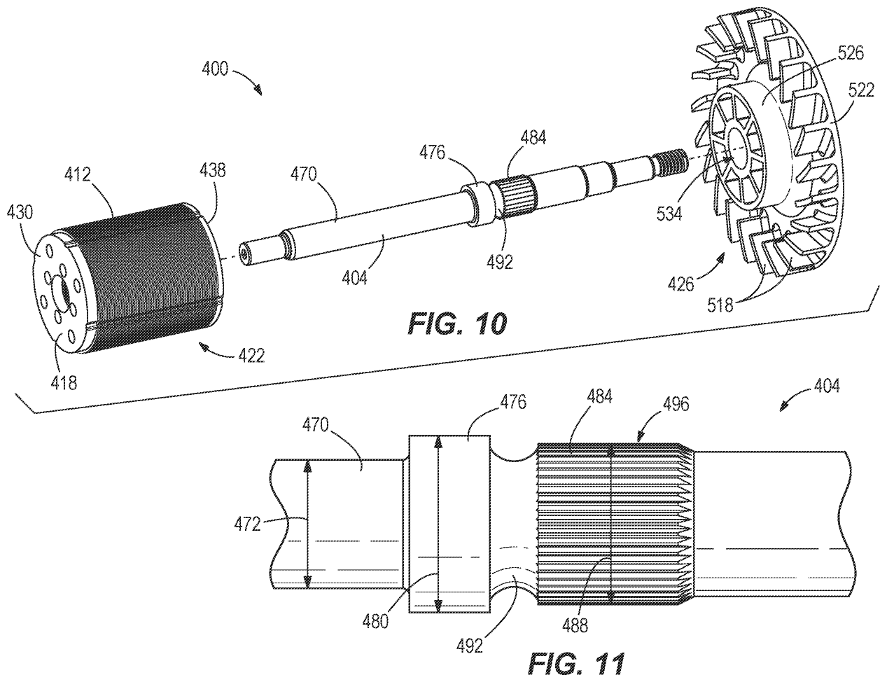

With reference to FIGS. 9 and 10, the molded rotor body 422 is like the molded rotor body 122 but does not include the coupler 146. The molded rotor body 422 includes a first magnet retention portion 430 (i.e., a first axial end cap) and a second magnet retention portion 438 (i.e., a second axial end cap). In the illustrated embodiment, the molded rotor body 422 does not extend beyond the second magnet retention portion 438.

With reference to FIGS. 10 and 11, the shaft 404 includes a smooth portion 470 defining a shaft diameter 472, a first portion 476 defining a first diameter 480, a second portion 484 defining a second diameter 488, and a notch 492 positioned between the first portion 476 and the second portion 484 and extending circumferentially about the shaft 404. The first diameter 480 is larger than the second diameter 488. The first portion 476 is positioned axially closer to the smooth portion 470 than the second portion 484. In other words, the first portion 476 is positioned between the smooth portion 470 and the second portion 484. In the illustrated embodiment, the first portion 476 abuts the smooth portion 470 and the first diameter 480 is larger than the shaft diameter 472. The second portion 484 includes outer diameter knurling 496 to rotationally lock the fan 426 to the shaft 404.

With reference to FIGS. 10 and 12, the fan 426 includes vanes 518, an end plate 522, a mounting hub 526, and an opening 534 extending through the mounting hub 526 and the end plate 522. With reference to FIG. 12, a rib 536 is formed in the opening 534 of the mounting hub 526. In the illustrated embodiment, the rib 536 is an annular rib that protrudes radially inward and extends in a circumferential direction. The fan 426 is assembled onto the shaft 404 such that the mounting hub 526 is positioned around the portions 476, 484 and the rib 536 of the fan 426 is received within the notch 492 of the shaft 404. The first portion 476 helps locate the fan 426 in the proper axial and radial location with respect to the shaft 404. The notch 492 and the rib 536 form a snap fitting between the shaft 404 and the fan 426. The outer diameter knurling 496 on the second portion 484 rotationally locks the fan 426 relative to the shaft 404.

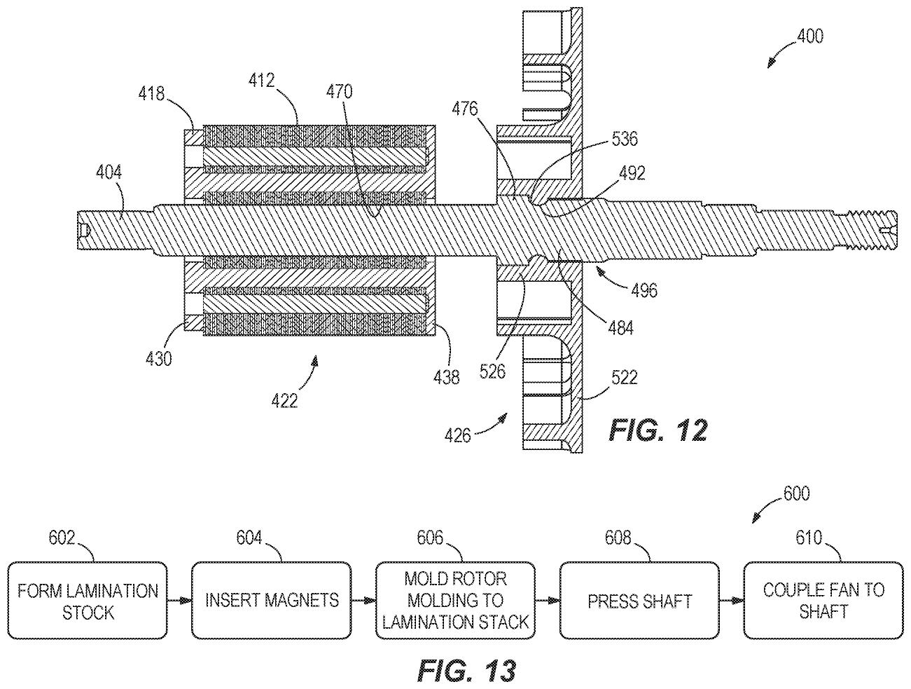

FIG. 13 illustrates a method 600 of manufacturing a rotor assembly for an electric motor according to the present invention. In general, the illustrated method 600 includes a step 602 to form a rotor core, a step 604 to insert permanent magnets into magnet slots formed in the rotor core, a step 606 to mold a rotor molding to the rotor core to form a molded rotor body, a step 608 to press a shaft into a central aperture formed in the molded rotor body, and a step 610 to snap-fit a fan to the shaft. The method 600 of FIG. 13 differs from prior art methods in that the pressing of the shaft occurs at step 608 after the rotor molding is molded to the rotor core at step 606. In addition, the method 600 of FIG. 13 differs from prior art methods in that the fan is coupled to the shaft at step 610 after the pressing of the shaft at step 608. In some embodiments, the process may omit one or more of the steps 602 and 604 yet still fall within the scope of the present invention. In some embodiments, the process may conduct step 608 and step 610 in reverse order (i.e., the fan is pressed on before the shaft is pressed into the rotor core).

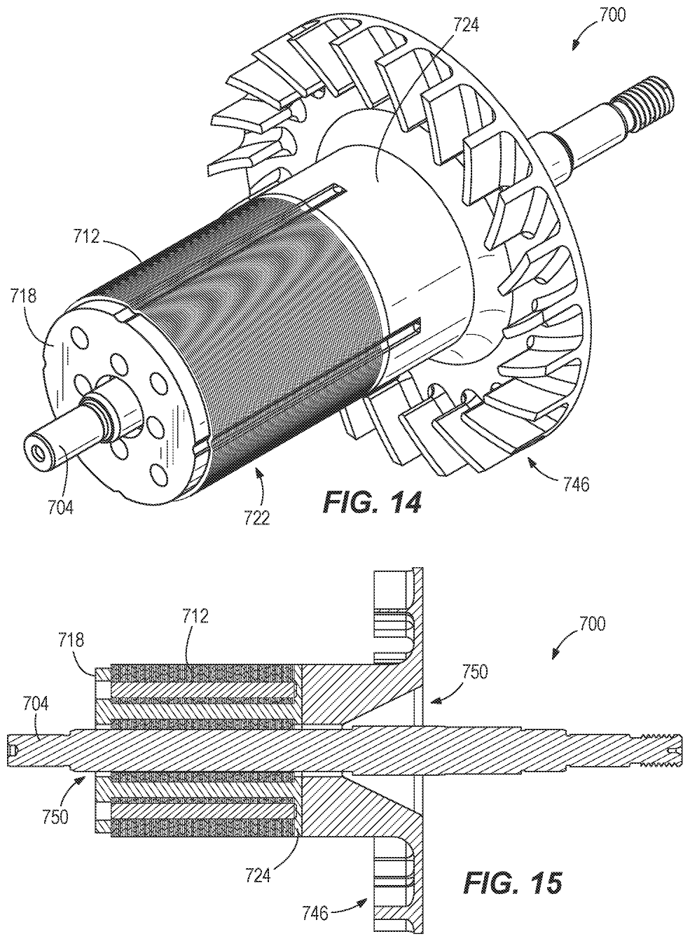

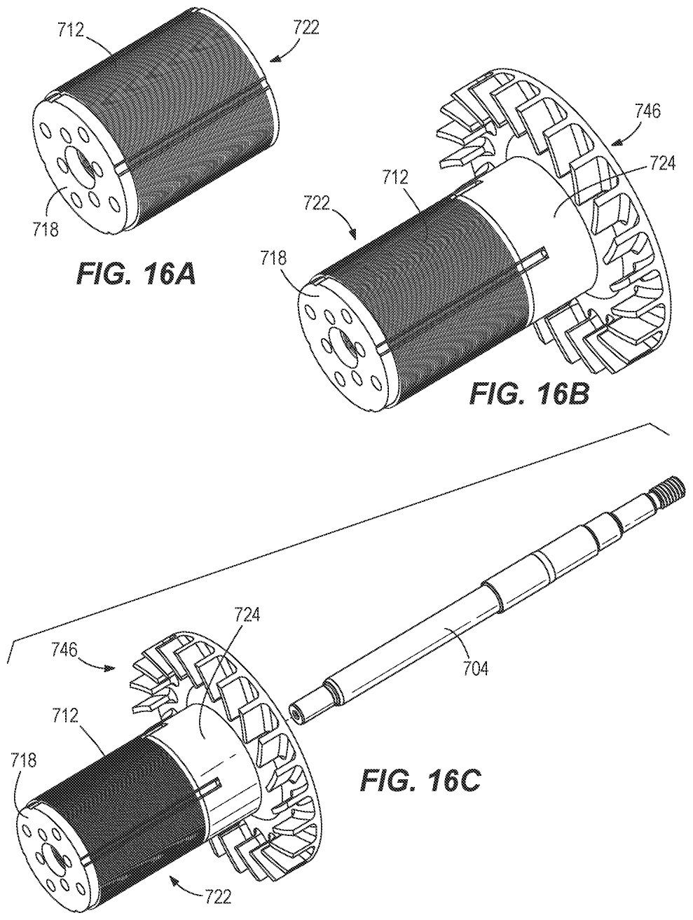

FIGS. 14-16C illustrate another embodiment of a molded rotor assembly 700 like the molded rotor assembly 100 described above, with like features shown with reference numerals plus “600.” The rotor assembly 700 includes a rotor core 712, a first rotor molding 718 that is molded to the rotor core 712 to form a molded rotor body 722 (FIG. 16A) and a second rotor molding 724 that is molded onto the molded rotor body 722. The second rotor molding 724 forms the fan 746. With reference to FIG. 15, the second rotor molding 724 abuts the first rotor molding 718. The shaft 704 is press-fitted through the rotor core 712 and corresponding openings 750 in the first rotor molding 718 and the second rotor molding 724.

With reference to FIG. 16A, the molded rotor body 722 is formed after the first rotor molding 718 is formed onto the rotor core 712. With reference to FIG. 16B, after the molded rotor body 722 is formed, the second rotor molding 724 is molded onto the molded rotor body 722. The second rotor molding 724 forms the fan 746. With reference to FIG. 16C, the shaft 704 is then press-fitted through the second rotor molding 724 and the molded rotor body 722. Like the press-fitting described above, the molded rotor body 722 and the second rotor molding 724 are rotationally coupled with the shaft 704. In the illustrated embodiment, the second rotor molding 724 abuts the first rotor molding 718. In other embodiments, there is a spacer (not shown) positioned between the second rotor molding 724 and the first rotor molding 718. In some embodiments, the second rotor molding 724 is formed of a different material than the first rotor molding 718. In other embodiments, the second rotor molding 724 is formed with the same material but in a different color than the first rotor molding 718.

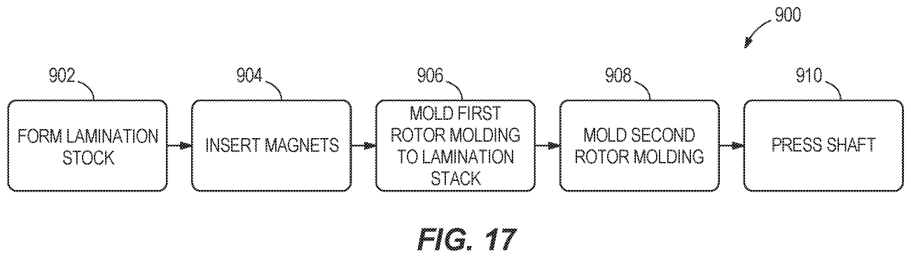

FIG. 17 illustrates a method 900 of manufacturing a rotor assembly for an electric motor according to the present invention. In general, the illustrated method 900 includes a step 902 to form a rotor core, a step 904 to insert permanent magnets into magnet slots formed in the rotor core, a step 906 to mold a first rotor molding to the rotor core to form a molded rotor body, a step 908 mold a second rotor molding (e.g., a fan) to the molded rotor body (i.e., a second, subsequent shot of injection molding) to form a fan and rotor body, and step 910 to press a shaft into a central aperture formed in the molded fan and rotor body. The method 900 of FIG. 17 differs from prior art methods in that the pressing of the shaft occurs at step 910 after the second rotor molding is molded at step 908 to an already molded rotor body. In some embodiments, the process may omit one or more of the steps 902 and 904 yet still fall within the scope of the present invention.

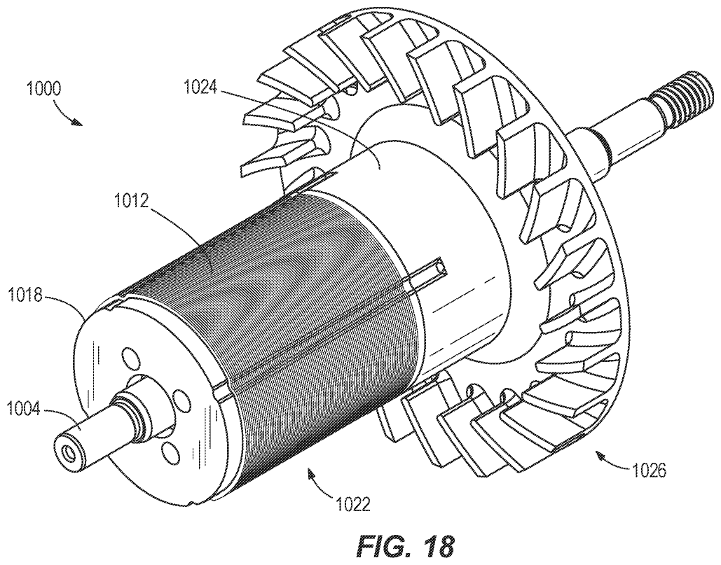

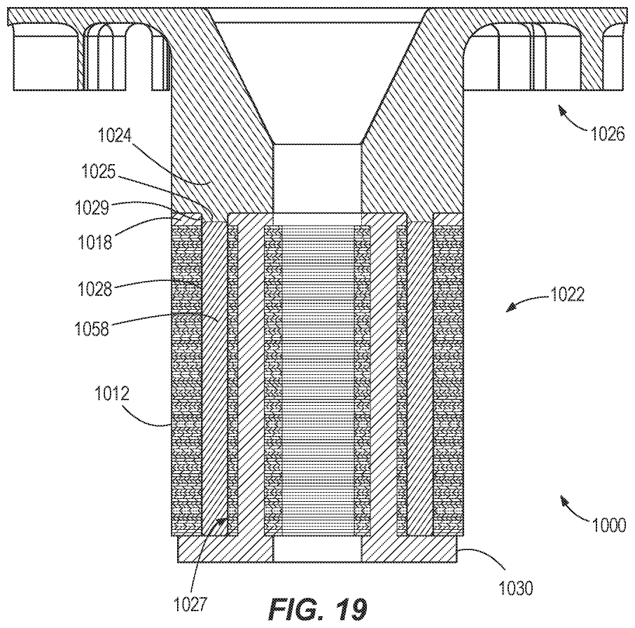

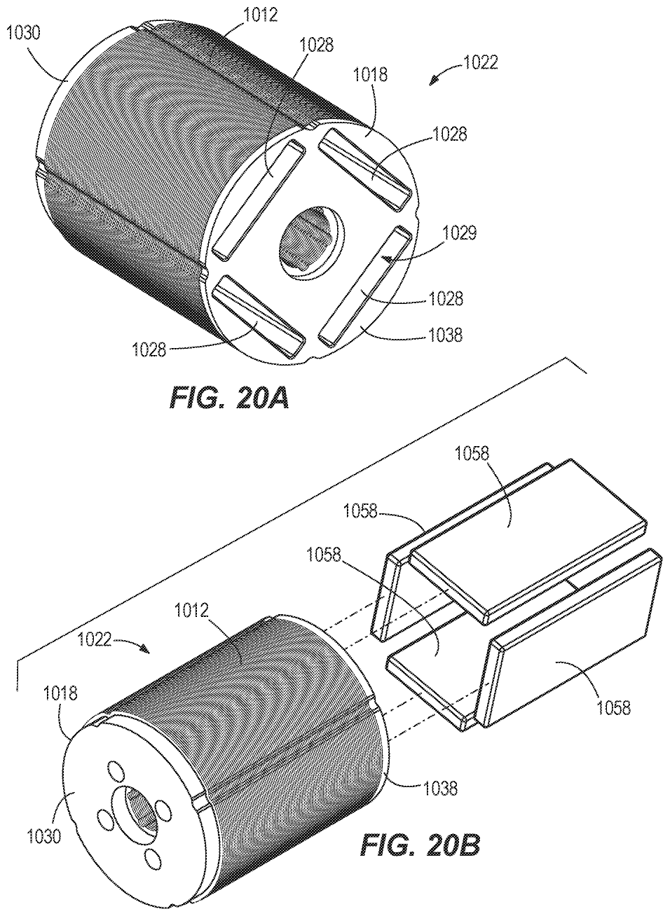

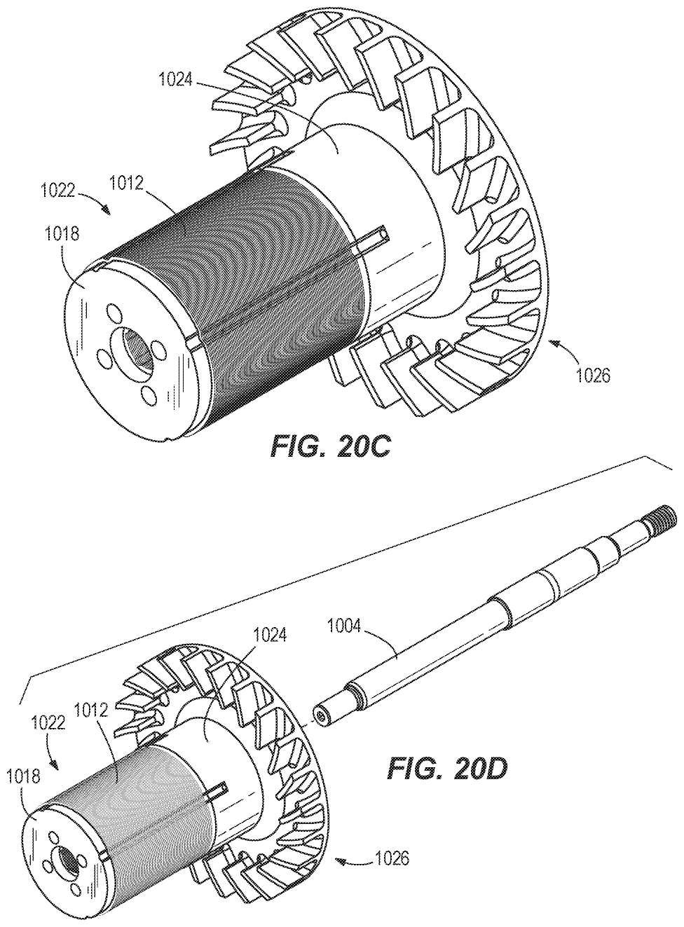

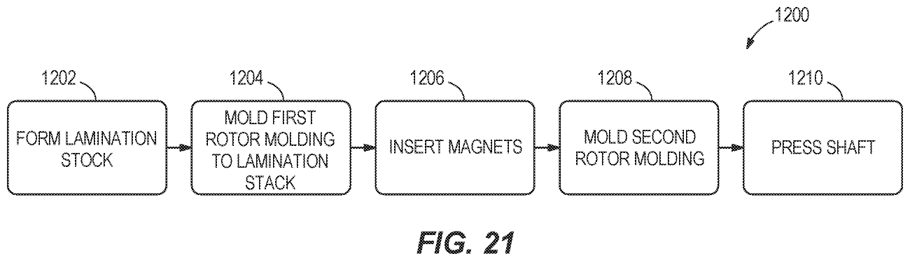

FIGS. 18-20D illustrate another embodiment of a molded rotor assembly 1000 like the molded rotor assembly 100 described above, with like features shown with reference numerals plus “900.” The rotor assembly 1000 includes a rotor core 1012, a first rotor molding 1018 that is molded to the rotor core 1012 to form a molded rotor body 1022 (FIG. 20A) and a second rotor molding 1024 that is molded onto the molded rotor body 1022. The second rotor molding 1024 forms the fan 1026. The rotor core 1012 defines a plurality of magnet slots 1027 extending therethrough in an axial direction. After the first rotor molding 1018 is formed (FIG. 20A), the first rotor molding 1018 defines a first axial end cap 1030 and a second axial end cap 1038. The first axial end cap 1030 covers the openings (not shown) of the magnet slots 1027 at one end of the rotor core 1012. The first rotor molding 1018 also forms pockets 1028 that are located within the magnet slots 1027 and that include thin walls covering each internal wall of the magnet slots 1027 within the rotor core 1012. The second axial end cap 1038 of the first rotor molding 1018 defines openings 1029 that provide access to each respective pocket 1028. The pockets 1028 are configured to receive magnets 1058. Each of the pockets 1028 has the material of the first rotor molding 1018 positioned on five sides. In other words, each of the pockets 1028 are accessible via a single opening 1029. The magnets 1058 are then inserted into the first molded rotor body 1022, or more specifically, the magnets 1058 are inserted into the pockets 1028 via the openings 1029. In other words, the magnets 1058 are inserted after the first rotor molding 1018 is molded to the rotor core 1012. Inserting the magnets 1058 after the molded rotor body 1022 is formed is easier because it can be performed outside of an injection mold (i.e., other designs require loading the rotor core and magnets into the plastic injection mold at the same time). With reference to FIG. 19, the second rotor molding 1024 abuts the first rotor molding 1018 and abuts the magnets 1058. In other words, the second rotor molding 1024 is positioned within the opening 1029 to secure the magnets 1058 within the pockets 1028 and rotor core 1012. In the illustrated embodiments, the second rotor molding 1024 includes a plug 1025 (FIG. 19) that is positioned within the opening 1029.

With reference to FIG. 20A, the molded rotor body 1022 is formed after the first rotor molding 1018 is formed onto the rotor core 1012. With reference to FIG. 20B, after the molded rotor body 1022 is formed, the magnets 1058 are inserted into the pockets 1028. With reference to FIG. 20C, the second rotor molding 1024 is molded onto the molded rotor body 1022. The second rotor molding 1024 forms the fan 1026. With reference to FIG. 20D, the shaft 1004 is then press-fitted through the second rotor molding 1024 and the molded rotor body 1022. Like the press-fitting described above, the molded rotor body 1022 and the second rotor molding 1024 are rotationally coupled with the shaft 1004. In the illustrated embodiment, the second rotor molding 1024 abuts the first rotor molding 1018 and is at least partially positioned within the pockets 1028 (FIG. 19). In some embodiments, the second rotor molding 1024 is formed of a different material than the first rotor molding 1018. In other embodiments, the second rotor molding 1024 is formed with the same material but in a different color than the first rotor molding 1018.

FIG. 21 illustrates a method 1200 of manufacturing a rotor assembly for an electric motor according to the present invention. In general, the illustrated method 1200 includes a step 1202 to form a rotor core, a step 1204 to mold a first rotor molding to the rotor core to form a molded rotor body, a step 1206 to insert permanent magnets into pockets formed in the molded rotor body, a step 1208 mold a second rotor molding (e.g., a fan) to the molded rotor body (i.e., a second, subsequent shot of injection molding) to form a fan and rotor body, and step 1210 to press a shaft into a central aperture formed in the molded fan and rotor body. The step 1208 of molding the second rotor molding also closes off the pockets to secure the magnets within the rotor core. The method 1200 of FIG. 21 differs from prior art methods in that the pressing of the shaft occurs at step 1210 after the second rotor molding is molded at step 1208 to an already molded rotor body. Also, the magnets are inserted at step 1206 after the molded rotor body is formed at step 1204. In some embodiments, the process may omit one or more of the steps 1202 and 1204 yet still fall within the scope of the present invention.

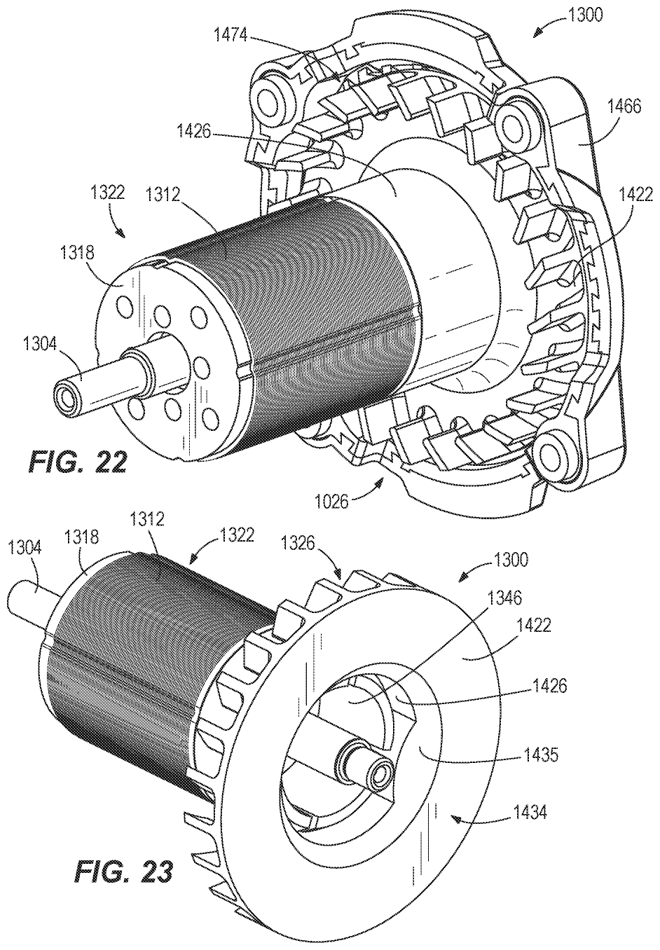

FIGS. 22-24 illustrate another embodiment of a molded rotor assembly 1300 like the molded rotor assembly 100 described above, with like features shown with reference numerals plus “1200.” The rotor assembly 1300 includes a shaft 1304, a rotor core 1312, a first rotor molding 1318 that is molded to the rotor core 1312 to form a molded rotor body 1322. A separate fan 1326 is coupled to the molded rotor body 1322. In the illustrated embodiment, the fan 1326 is snap-fitted onto the rotor molding 1318 by a snap fitting coupling like the one described above with respect to FIGS. 2-7. Specifically, the first rotor molding 1318 includes a coupler 1346 that is received by a mounting hub 1426 formed on the fan 1326.

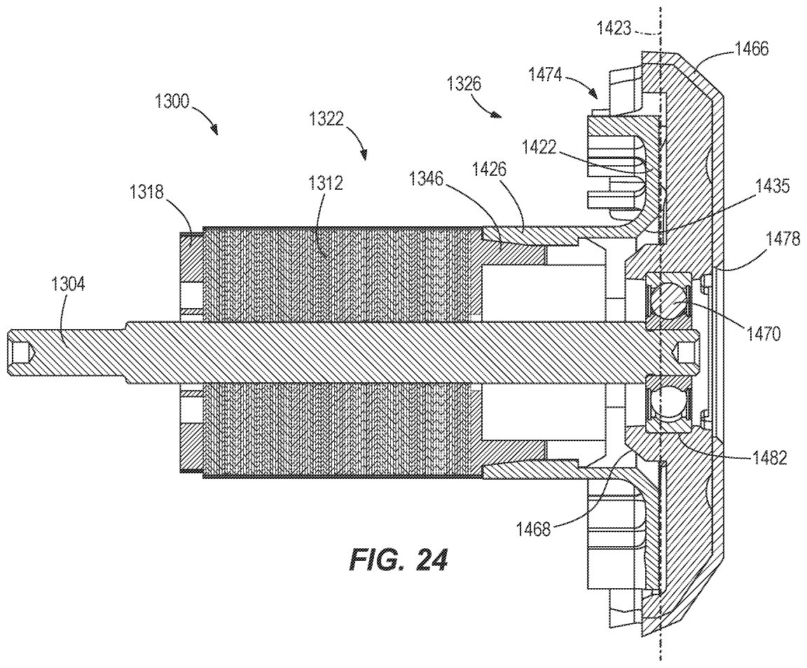

With continued reference FIGS. 22-24, the rotor assembly 1300 is shown with a casing 1466 and a bearing 1470. The casing 1466 may be a tool end cap, a gearcase, or the like. The casing 1466 at least partially defines a cavity 1474 (i.e., a chamber) in which to receive or partially shroud the fan 1326. With reference to FIG. 24, the casing 1466 includes an aperture 1478 through which the shaft 1304 extends and a channel 1482 to receive the bearing 1470. A portion 1468 of the casing 1466 extends into the center opening 1434 of the fan 1326. With reference to FIG. 23, the opening 1434 of the fan 1326 includes a conical portion 1435 that extends between an end plate 1422 and the mounting hub 1426. The conical portion 1435 provides clearance for the portion 1468 of the casing 1466 and the bearing 1470 to be partially received within the fan 1326.

With reference to FIG. 24, the end plate 1422 of the fan 1326 defines a plane 1423. In the illustrated embodiment, the plane 1423 represents an outer-most extent of the fan 1326. The bearing 1470 and the casing 1466 are at least partially received within the fan 1326. In other words, the bearing 1470 is sunk within the rotor assembly 1300. In the illustrated embodiment, the plane 1423 intersects the portion 1468 of the casing 1466 and the bearing 1470. In other embodiments, the entire bearing 1470 could be positioned to the left of the plane 1423 as viewed from the orientation of FIG. 24. In other words, in some embodiments, the bearing 1470 is positioned further within the rotor assembly 1300 such that the bearing 1470 is received entirely within the fan 1326. Positioning the bearing 1470 at least partially within the rotor assembly 1300 enables the overall axial length of the assembly, measured along the shaft 1304, to be shortened.

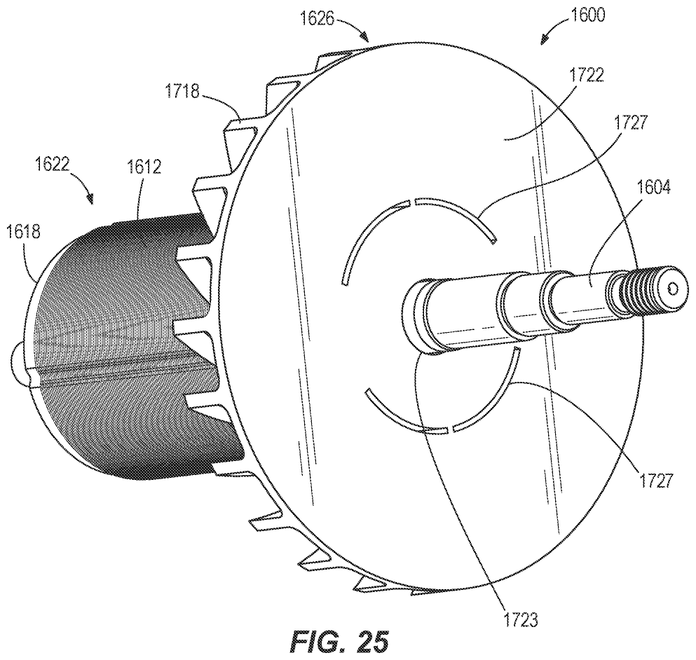

FIGS. 25-27 illustrate another embodiment of a molded rotor assembly 1600 like the molded rotor assembly 100 described above, with like features shown with reference numerals plus “1500.” The rotor assembly 1600 includes a shaft 1604, a rotor core 1612, a first rotor molding 1618 that is molded to the rotor core 1612 to form a molded rotor body 1622. A separate fan 1626 is coupled to the molded rotor body 1622. In the illustrated embodiment, the fan 1626 is snap-fitted onto the rotor molding 1618 by a snap fitting coupling like the one described above with respect to FIGS. 2-7. Specifically, the first rotor molding 1618 includes a coupler 1646 that is received by a mounting hub 1726 formed on the fan 1626.

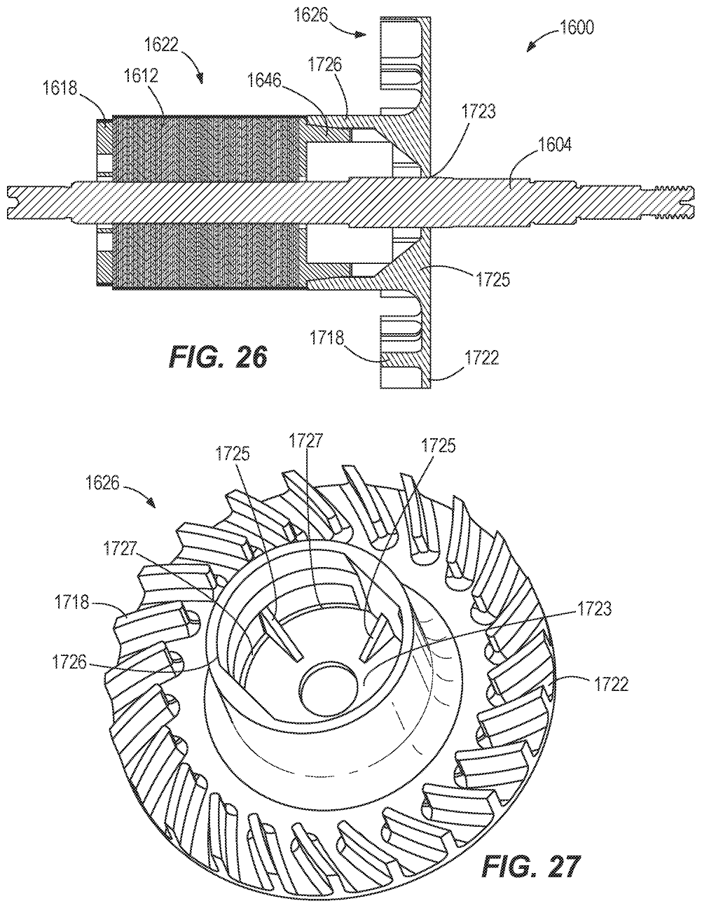

With continued reference to FIGS. 25-27, the fan 1626 includes a plurality of vanes 1718 formed on an end plate 1722 that generate an airflow upon rotation of the fan 1626. The mounting hub 1726 extends axially away from the end plate 1722. The fan 1626 includes an aperture 1723 formed in the end plate 1722. The aperture 1723 has a diameter sized to provide a tight or interference fit with the outer diameter of the shaft 1604 (FIG. 26). In other words, the end plate 1722 directly contacts the shaft 1604 that passes through the aperture 1723. With the aperture 1723 sized to fit around the shaft 1604, additional support is provided to the fan 1626 by the end plate 1722. Also, the portion of the end plate 1722 surrounding the shaft 1604 helps reduce unwanted vibration. Ribs 1725 are also formed between the interior of the mounting hub 1726 and the end plate 1722 to provide additional strength. In addition, the fan 1626 includes a plurality of slots 1727 formed in the end plate 1722 to allow for the forming of other features (e.g., the snap-fit coupling) with a simplified injection mold (i.e., a simple open/shut injection mold). In the illustrated embodiment, the slots 1727 are arcuate.

Various features of the disclosure are set forth in the following claims.

1. An electric motor comprising:
a stator; and
a rotor assembly received in the stator, the rotor assembly including
a shaft,
a rotor core,
a rotor molding that is molded to the rotor core,
a fan,
a coupler formed on the rotor molding, and
a corresponding mounting hub formed on the fan;
wherein the shaft is pressed into the rotor core after the rotor molding is molded to the rotor core, and wherein the fan is affixed to the rotor molding by connecting the coupler and the mounting hub after the shaft is pressed into the rotor core.

2. The electric motor of claim 1, wherein a bearing is at least partially received within the fan and configured to support the shaft.

3. The electric motor of claim 2, wherein the bearing is received entirely within the fan.

4. The electric motor of claim 2, wherein an axially outermost face of the fan defines a plane that extends perpendicular to the shaft, and wherein the plane intersects the bearing.

5. The electric motor of claim 1, wherein the fan directly contacts the shaft after the fan is affixed to the rotor molding.

6. The electric motor of claim 5, wherein the fan includes an end plate that defines an aperture sized to provide an interference fit with an outside diameter of the shaft.

7. The electric motor of claim 6, wherein a plurality of slots are defined in the end plate.

8. The electric motor of claim 1, wherein the coupler includes a lip formed at a distal end, and the mounting hub includes a ledge that engages the lip to secure the fan to the rotor molding.

9. The electric motor of claim 8, wherein the coupler includes planar portions, and the mounting hub includes linear portions configured to engage the planar portions to rotationally lock the fan relative to the rotor molding.

10. The electric motor of claim 8, wherein the coupler includes a first beveled portion that engages a second beveled portion formed on the mounting hub to hold the ledge against the lip.

11. A method of manufacturing an electric motor, the method comprising:
molding a rotor molding to a rotor core, the rotor molding including a coupler formed thereon;
pressing a shaft into the rotor core;
connecting the coupler to a mounting hub formed on a fan to thereby affix the fan to the rotor molding and form a rotor assembly; and
receiving the rotor assembly into a stator.

12. The method of claim 11, wherein the fan is configured to at least partially receive a bearing configured to support the shaft.

13. The method of claim 12, wherein the fan is configured to entirely receive the bearing.

14. The method of claim 12, wherein an axially outermost face of the fan defines a plane that extends perpendicular to the shaft, and wherein the plane intersects the bearing.

15. The method of claim 11, wherein the fan directly contacts the shaft after the fan is affixed to the rotor molding.

16. The method of claim 15, wherein the fan includes an end plate that defines an aperture sized to provide an interference fit with an outside diameter of the shaft.

17. The method of claim 16, wherein a plurality of slots are defined in the end plate.

18. The method of claim 11, wherein the coupler includes a lip formed at a distal end, and the mounting hub includes a ledge that engages the lip to secure the fan to the rotor molding.

19. The method of claim 18, wherein the coupler includes planar portions, and the mounting hub includes linear portions configured to engage the planar portions to rotationally lock the fan relative to the rotor molding.

20. The method of claim 18, wherein the coupler includes a first beveled portion that engages a second beveled portion formed on the mounting hub to hold the ledge against the lip.

21.-50. (canceled)
